(19) United States
(12) Patent Application Publication
(10) Pub. No.: US 2017/0286871 A1
(43) Pub. Date: Oct. 5, 2017

(54) Method and Electronic Device for Buying Movie Ticket Online

(71) Applicants: Le Holdings (Beijing) Co., Ltd., Beijing (CN); Lemall (Beijing) Co., Ltd., Beijing (CN)

(72) Inventors: Tianxiang Zheng, Beijing (CN); Yu Bai, Beijing (CN)

(21) Appl. No.: 15/245,801

(22) Filed: Aug. 24, 2016

Related U.S. Application Data
(63) Continuation of application No. PCT/CN2016/089776, filed on Jul. 12, 2016.

(30) Foreign Application Priority Data
Mar. 30, 2016 (CN) 2016101923997

(51) Int. Cl. G06Q 10/02

(52) U.S. Cl. CPC G06Q 10/02

(57) ABSTRACT

The present disclosure discloses a method and device for buying a movie ticket online. The method for buying a movie ticket online includes the following steps of: an acquisition step for acquiring attribute information of the movie ticket which a user intends to buy; an identification step for identifying a behavior that the user adds the desired movie ticket commodity into a shopping cart; and a settlement step for carrying out settlement on a movie ticket amount paid by the user. According to the present disclosure, by putting the desired movie ticket into the shopping cart and then carrying out settlement, a commodity settling system of a shopping website can be simplified and no additional settling system needs to be added for settlement of virtual commodities, such as movie tickets and the like, so that labor of a background maintenance worker is greatly saved.

### CROSS REFERENCE TO RELATED APPLICATIONS

This application is a continuation of International Application No. PCT/CN2016/089776, filed Jul. 12, 2016, and claims priority to Chinese Patent Application No. 201610192399.7, filed Mar. 30, 2016, the disclosures of which are hereby incorporated in their entirety by reference.

### TECHNICAL FIELD

The present disclosure relates to the field of online shopping, and particularly relates to a method and electronic device for buying a movie ticket online.

### BACKGROUND

With development of the internet network and smart mobile devices, more and more users select shopping online so as to obtain commodities conveniently and rapidly. Through an online shopping mall which is a network platform, users can inquire information, such as price and the like, of all products provided by all merchants entering the online shopping mall at any time. Currently, there are more and more online shopping malls, such as Taobao, Alibaba and Jingdong Mall at the beginning, Letv Mall at present and the like, and competition among the online shopping malls is also increasingly intense.

In conventional shopping websites, a common purchase mode for virtual commodities, such as movie tickets and the like, is a direct purchase mode. That is to say, after the user clicks a “buy” icon, a settlement page is directly shown to carry out payment. Although this buying mode avoids a step for adding the virtual commodities into a shopping cart, which seemingly simplifies the purchase process to a certain degree, this buying mode has great defects. On one hand, in this paying mode, the shopping website needs two sets of payment systems, one set of payment system is used for direct payment, the other set of payment system corresponds to commodity payment placed in the shopping cart, which becomes a high pressure and a heavy load for operation cost and maintenance cost of the website. On the other hand, a network user usually will buy multiple commodities at one time in the online shopping, but the virtual commodities, such as movie tickets and the like, need to be settled separately, so that the user needs to carry out settlement twice or more times, thereby causing inconvenience in operation and greatly affecting user experience.

Information disclosed in the background art is intended to facilitate understanding of the overall background of the present disclosure, and shall not be deemed as admitting or implying in any form that this information constitutes the prior art well known by those skilled in the art.

### SUMMARY

The present disclosure aims to provide a method and an electronic device for buying a movie ticket online in which the buying information of the movie ticket can be put into a shopping cart and then settlement of movie tickets is carried out via the shopping cart.

The present disclosure further aims to provide a method and an electronic device for buying a movie ticket online. The movie ticket as well as derivative products corresponding to the movie ticket can be added into the shopping cart conveniently, thereby improving user experience and operation incomes of an online shopping mall.

To this end, an embodiment of the present disclosure provides a method for buying movie a ticket online, which includes the following steps an acquisition step for acquiring attribute information of the movie ticket which a user intends to buy; an identification step for identifying a behavior that the user adds the desired movie ticket into a shopping cart; and a settlement step for settling the money of the movie ticket paid by the user.

In a second aspect, an embodiment of the present disclosure provides an electronic device, which includes: at least one processor; and a memory communicably connected with the at least one processor for storing instructions executable by the at least one processor. The execution of the instructions by the at least one processor causes the at least one processor to: acquire attribute information of the movie ticket which a user intends to buy; identify a behavior that the user adds the desired movie ticket into a shopping cart; and settle the money of the movie ticket paid by the user.

In a third aspect, an embodiment of the present disclosure provides a non-transitory computer-readable storage medium which stores executable instructions. When executed by an electronic device, the executable instructions cause the electronic device to: acquire attribute information of the movie ticket which a user intends to buy; identify a behavior that the user adds the desired movie ticket into a shopping cart; and settle the money of the movie ticket paid by the user.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a preferred embodiment of a method for buying a movie ticket online according to the present disclosure.

FIG. 2 is a flow chart of another preferred embodiment of a method for buying a movie ticket online according to the present disclosure.

FIG. 3 is a flowchart of a further preferred embodiment of a method for buying a movie ticket online according to the present disclosure.

FIG. 4 is a schematic diagram of a device for buying a movie ticket online according to the present disclosure.

FIG. 5 is a structural block diagram of an electronic device capable of implementing the method for buying a movie ticket online according to the present disclosure.

### DETAILED DESCRIPTION OF THE PREFERRED EMBODIMENTS

The specific embodiments of the present disclosure will be further described in details in conjunction with the accompany drawings, but it should be understood that the scope of the present disclosure is not limited to the specific embodiments.

Unless otherwise defined, in the overall description and claims, words “include” or its transforms, such as “comprise” or “have” and the like, shall be understood to include the elements or components, not exclusive of other elements or components.

### Embodiment 1

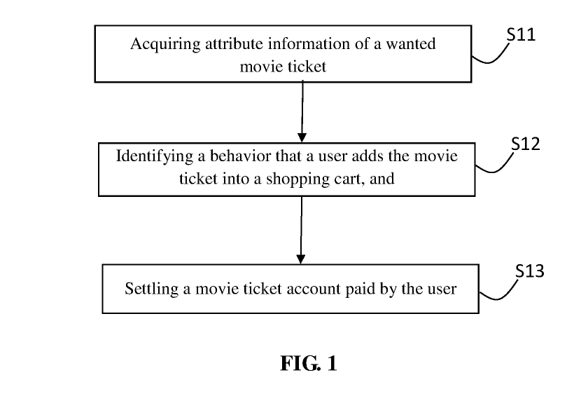

FIG. 1 shows a preferred embodiment of a method for buying a movie ticket online according to the present disclosure. As shown in FIG. 1, when a user browses a shopping website and if the user plans to buy a movie ticket on the website, the user selects attribute information of the movie ticket, such as price, quantity, start time of the movie, a specific cinema and the like. In S11, an acquisition module of a server acquires the attribute information of the movie ticket which the user wants to buy. Next, the difference between a conventional movie ticket buying mode and the present disclosure is that in the method according to the present disclosure, after the user selects the desired movie ticket, the movie ticket will be added into a shopping cart, then in S12, an identification module of the server will identify a behavior that the user adds the movie ticket into the shopping cart. Next, the user pays for the movie ticket in the shopping cart, and in S13, a settlement module of the server carries out charging and settlement on the payment so as to complete the integral buying process of the movie ticket.

### Embodiment 2

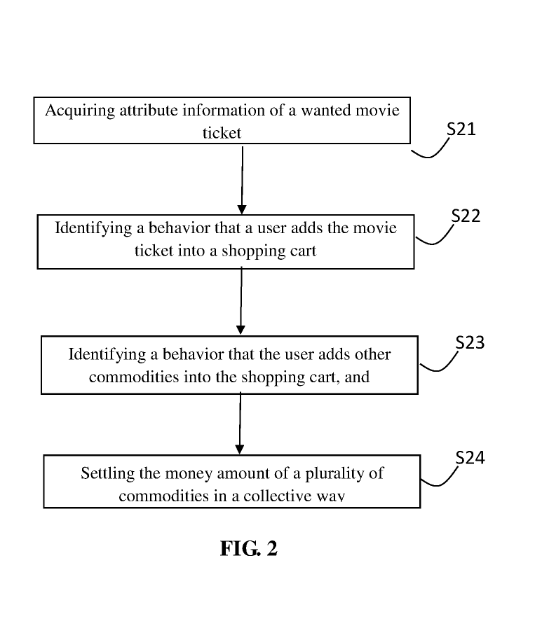

FIG. 2 shows another preferred embodiment of a method for buying a movie ticket online according to the present disclosure. As shown in FIG. 2, when a user browses a shopping website and if the user plans to buy a movie ticket on the website, the user selects attribute information of the movie ticket, such as price, quantity, screening schedule, a certain specific cinema and the like. In S21, a server acquires the attribute information of the movie ticket which the user wants to buy. Next, in the method according to the present disclosure, after the user selects the desired movie ticket, the movie ticket will be added into a shopping cart, and then in S12, the server will identify a behavior that the user adds the movie ticket into the shopping cart. The user usually will simultaneously buy multiple commodities when browsing the shopping website, other commodities are all added into the shopping cart in a similar mode, and then in S23, a behavior that the user adds other commodities into the shopping cart is identified. It should be illustrated that S22 and S23 have no compulsive sequential relationship and can be exchanged mutually in sequence, the step sequence numbers are only intended to distinguish different steps, but do not represent that the present disclosure needs to be executed according to the sequence. Next, the user pays for the movie ticket and other commodities in the shopping cart, and in S24, the server carries out charging and settlement on the payment so as to complete the whole buying process of the movie ticket and other commodities.

### Embodiment 3

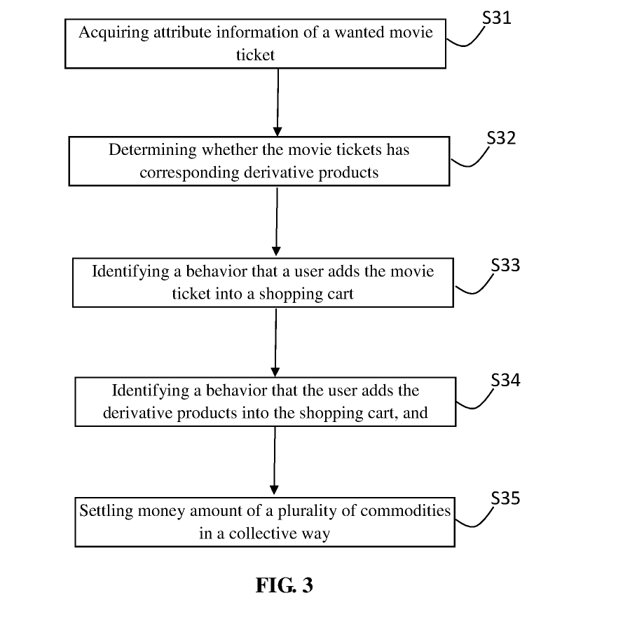

FIG. 3 shows another preferred embodiment of a method for buying a movie ticket online according to the present disclosure. As shown in FIG. 3, when a user browses a shopping website and if the user plans to buy a movie ticket on the website, the user selects attribute information of the movie ticket, such as price, a number, screening schedule, a certain specific cinema and the like. In S31, a server acquires the attribute information of the movie ticket which the user wants to buy. Next, in S32, the server determines whether the movie ticket has corresponding derivative products according to the attribute information. Information of the derivative products is displayed on a webpage used for selling the movie ticket.

Next, after the user selects the desired movie ticket, the movie ticket will be added into a shopping cart, and then in S33, the server will identify a behavior that the user adds the movie ticket into the shopping cart. At the moment, if the user selects to buy the derivative products, in S34, the server will identify a behavior that the user adds the derivative products into the shopping cart.

It should be illustrated that S32 and S33 can be exchanged mutually. Namely, after the server identifies the behavior that the user adds the movie ticket into the shopping cart, a plurality of derivative products related to the movie ticket can be displayed on a webpage, and the derivative products can be directly added into the shopping cart or are added into the shopping cart after the user clicks on links of the derivative products to enter product instruction pages. Optionally, a system can pop out instruction information of the derivative products after or when the user selects the attribute information of the movie ticket, such as a screening number, seat No. and the like, and at this moment, the user can click on the links of the derivative products or directly put the derivative products into the shopping cart. Next, the user pays for the movie ticket and the derivative products thereof in the shopping cart, and in S35, the server carries out charging and settlement on the payment so as to complete the whole buying process of the movie ticket and derivative commodities.

Preferably, in the embodiment, whether the movie ticket has the corresponding derivative products can be determined according to the attribute information; and the information of the derivative products is displayed on the webpage used for selling the movie tickets, wherein the attribute information includes one or more of the followings: merchant information, name, content, quantity and price of the movie ticket. The derivative products are at least one type of foods and dolls or mascots corresponding to characters of a movie.

Preferably, in the embodiment, the method includes: pre-storing relationships between the movie ticket and the corresponding derivative products; and according to the relationships, determining whether the movie ticket has the corresponding derivative products.

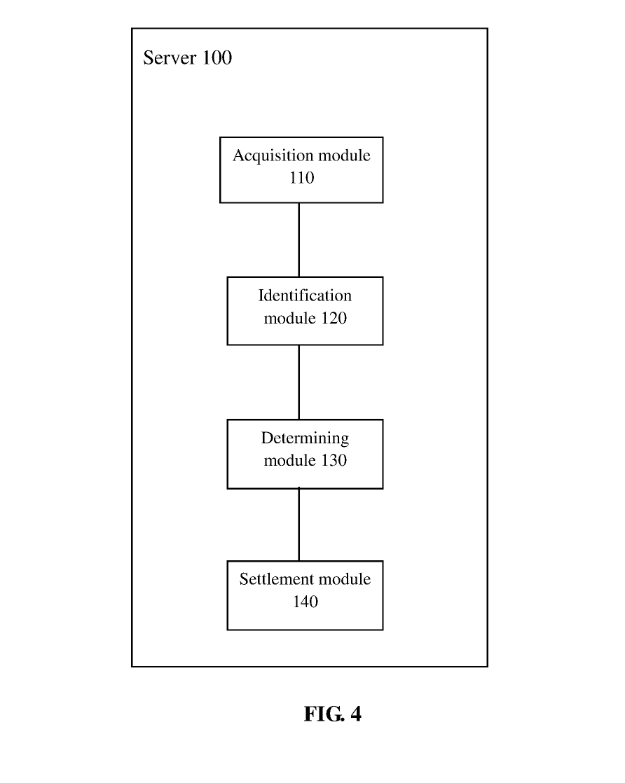

FIG. 4 is a schematic diagram of a device for buying a movie ticket online according to the present disclosure, wherein a server 100 of a shopping website includes an acquisition module 110, which is used for acquiring attribute information of the movie ticket which a user intends to buy; an identification module 120, which is connected with the acquisition module 110 and is used for confirming a behavior that the user adds the desired movie ticket commodity into a shopping cart; and a settlement module 140, which is used for carrying out settlement on a movie ticket amount paid by the user.

Preferably, the server 100 further includes a determining module 130, which is used for determining whether the movie ticket has corresponding derivative products according to the attribute information.

Working modes of the modules have been described in details in the embodiments 1 to 3 and are not repeated herein.

From the above, according to the method for buying a movie ticket online, which is provided by the present disclosure, by putting the desired movie ticket commodity into the shopping cart and then carrying out settlement, a commodity settling system of the shopping website can be simplified and a new settling system does not need to be additionally developed for settlement of virtual commodities, such as movie tickets and the like, so that labor of a background maintenance worker is greatly saved; in addition, according to the method for buying a movie ticket online, which is provided by the present disclosure, the user also can select and buy the derivative products associated to the movie ticket while buying the movie ticket, thereby greatly increasing operation incomes of the shopping website, and meanwhile, the user can carry out settlement on the movie ticket and the derivative products thereof together, thereby facilitating shopping of the user.

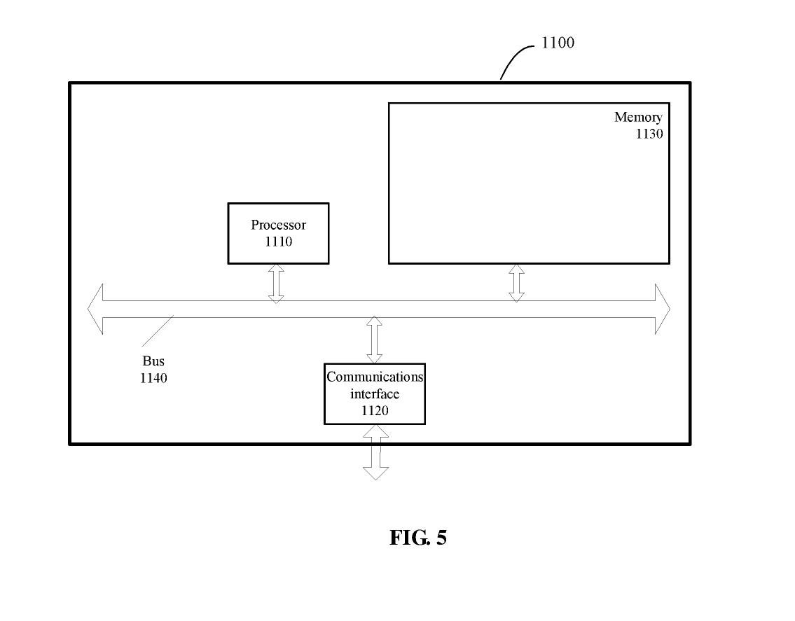

FIG. 5 is a structural block diagram of an electronic device capable of implementing the method for buying a movie ticket online according to the present disclosure. The electronic device 1100 can be a host server, a PC (Personal Computer), or a portable computer or terminal which has computing capacity. The specific embodiments of the present disclosure do not define the specific implementations of computing nodes.

The electronic device 1100 includes a processor 1110, a communications interface 1120, a memory (memory array) 1130 and a bus 1140, wherein the processor 1110, the communications interface 1120 and the memory 1130 complete mutual communication by the bus 1140.

The communications interface 1120 is used for being communicated with network elements, wherein the network elements include a virtual machine management center, a shared memory and the like for example.

The processor 1110 is used for executing a program. The processor 1110 possibly is a CPU (Central Processing Unit) or an ASIC (Application Specific Integrated Circuit), or is configured as one or a plurality of integrated circuits for implementing the embodiments of the disclosure.

The memory 1130 is used for storing files. The memory 1130 possibly includes a high-speed RAM (Random Access Memory), and also possibly further includes a non-volatile memory, and for example, at least one disk memory. The memory 1130 also can be a memory array. The memory 1130 also may be blocked, and the blocks can be combined into a virtual volume according to a certain rule.

In one possible embodiment, the program can be program codes including computer operation instructions. Such computer operation instructions can be stored in a non-transitory computer-readable storage medium. The computer operation instructions can be executed by a processor or by an electronic device including a processor. Execution of the instructions by the processor can cause the processor or can cause the electronic device to: acquire attribute information of the movie ticket which a user intends to buy; identify a behavior that the user adds the desired movie ticket into a shopping cart; and settle the money of the movie ticket paid by the user. In a possible embodiment, execution of the instructions by the processor further causes the at least one processor to: determine whether the movie ticket has corresponding derivative products, according to the attribute information; and display information of the derivative products on a same webpage as the one used for selling the movie ticket.

In a possible embodiment, execution of the instructions by the processor further causes the at least one processor to: pre-store relationships between the movie ticket and the corresponding derivative products; and according to the relationships, determine whether the movie ticket has the corresponding derivative products.

In a possible embodiment, execution of the instructions by the processor further causes the at least one processor to: add the derivative products into the shopping cart before settling the money of the movie ticket paid by the user.

Those skilled in the art should understand that the embodiments of the present disclosure can be provided as a method, a system or a computer program product. Therefore, the present disclosure can adopt a form of hardware embodiments, software embodiments, or embodiments combining software and hardware. Moreover, the present disclosure can adopt a form of the computer program product implemented on one or more computer available storage media (including, but not limited to, a disk memory, an optical memory and the like) including computer available program codes.

It should be understood that in the device and/or the method of the present disclosure, all the steps can be sequentially executed according to the sequence described in the description, but also can be carried out in parallel or independently, so long as the same or equivalent technical effects can be achieved.

The specific exemplar embodiments of the present disclosure are described for illustration and exemplification. Those descriptions are not intended to define the present disclosure into the disclosed accurate forms, and it is obvious that according to the above teaching, many changes and variations can be made to the present disclosure. The exemplary embodiments are selected and described to explain the specific principle and practical application of the present disclosure, so that those skilled in the art can implement and utilize various different exemplary embodiments and various different selections and changes of the present disclosure. The scope of the present disclosure is intended to be defined by the claims and its equivalent forms.

What is claimed is:

1. A method for buying a movie ticket online, adapted to be used by a server, said method comprising:
an acquisition step for acquiring attribute information of the movie ticket which a user intends to buy;
an identification step for identifying a behavior that the user adds the desired movie ticket into a shopping cart; and
a settlement step for settling the money of the movie ticket paid by the user.

2. The method according to claim 1, further comprising: determining whether the movie ticket has corresponding derivative products, according to the attribute information; and
displaying information of the derivative products on a same webpage as the one that is used for selling the movie ticket.

3. The method according to claim 1, further comprising:
pre-storing relationships between the movie ticket and the corresponding derivative products; and
according to the relationships, determining whether the movie ticket has the corresponding derivative products.

4. The method according to claim 1, wherein the attribute information comprises at least one of the following: merchant information, name, content, quantity, and price of the movie ticket.

5. The method according to claim 2, wherein the derivative products are at least one type of foods and dolls or mascots corresponding to characters of a movie.

6. The method according to claim 2, further comprising:
a step for adding the derivative products into the shopping cart before the settlement step.

7. An electronic device, comprising:
at least one processor; and
a memory communicably connected with the at least one processor for storing instructions executable by the at least one processor, wherein execution of the instructions by the at least one processor causes the at least one processor to:
acquire attribute information of the movie ticket which a user intends to buy;
identify a behavior that the user adds the desired movie ticket into a shopping cart; and
settle the money of the movie ticket paid by the user.

8. The electronic device according to claim 7, wherein execution of the instructions by the at least one processor further causes the at least one processor to:
determine whether the movie ticket has corresponding derivative products, according to the attribute information; and
display information of the derivative products on a same webpage as the one used for selling the movie ticket.

9. The electronic device according to claim 7, wherein execution of the instructions by the at least one processor further causes the at least one processor to:
pre-store relationships between the movie ticket and the corresponding derivative products; and
according to the relationships, determine whether the movie ticket has the corresponding derivative products.

10. The electronic device according to claim 7, wherein the attribute information comprises at least one of the following: merchant information, name, content, quantity, and price of the movie ticket.

11. The electronic device according to claim 8, wherein the derivative products are at least one type of foods and dolls or mascots corresponding to characters of a movie.

12. The electronic device according to claim 8, wherein execution of the instructions by the at least one processor further causes the at least one processor to:
add the derivative products into the shopping cart before settling the money of the movie ticket paid by the user.

13. A non-transitory computer-readable storage medium storing executable instructions thereon, which, when executed by an electronic device, cause the electronic device to:
acquire attribute information of the movie ticket which a user intends to buy;
identify a behavior that the user adds the desired movie ticket into a shopping cart; and
settle the money of the movie ticket paid by the user.

14. The non-transitory computer-readable storage medium according to claim 13, wherein execution of the instructions further causes the electronic device to:
determine whether the movie ticket has corresponding derivative products, according to the attribute information; and
display information of the derivative products on a same webpage as the one used for selling the movie ticket.

15. The non-transitory computer-readable storage medium according to claim 13, wherein execution of the instructions further causes the electronic device to:
pre-store relationships between the movie ticket and the corresponding derivative products; and
according to the relationships, determine whether the movie ticket has the corresponding derivative products.

16. The non-transitory computer-readable storage medium according to claim 13, wherein the attribute information comprises at least one of the following: merchant information, name, content, quantity, and price of the movie ticket.

17. The non-transitory computer-readable storage medium according to claim 14, wherein the derivative products are at least one type of foods and dolls or mascots corresponding to characters of a movie.

18. The non-transitory computer-readable storage medium according to claim 14, wherein execution of the instructions further causes the electronic device to:
add the derivative products into the shopping cart before settling the money of the movie ticket paid by the user.
